(19) United States
(12) Patent Application Publication
(10) Pub. No.: US 2009/0141600 A1
(43) Pub. Date: Jun. 4, 2009

(54) DATA ERROR MEASURE BASED RECORDING SPEED CONTROL

(75) Inventors: Tony Petrus Van Endert, Eindhoven (NL); Erno Fancsali, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,363

(22) PCT Filed: Oct. 17, 2005
(86) PCT No.: PCT/IB2005/053394

§ 371 Date: Apr. 17, 2007

(30) Foreign Application Priority Data
Oct. 22, 2004 (EP) 04105259.8

(51) Int. Cl. G11B 15/52

(52) U.S. Cl. 369/47.36; G9B/15.072

(57) ABSTRACT

The present invention relates to determining a data writing speed for writing data on a medium (112, 40, 50), using a predetermined writing power, comprising writing a test data sequence on the medium using a first data writing speed (step 204), reading the written test data sequence from the medium (step 206), determining a written data error measure for the written test data sequence (step 210), and selecting a lower second data writing speed if the written data error measure is higher than a written data error threshold (steps 212, 216). It also relates to writing data on a medium, using a data writing speed, comprising writing data on a first part (56) of the medium (50, step 312), using the first data writing speed, and writing data on a second part (54) of the medium (50, step 314), using a speed related to the second data writing speed.

The present invention relates to determining a data writing speed for writing data on a medium, based on monitoring the occurrence of test data errors.

During radial and axial tracking on a rotating optical disc, tracking errors may occur. These tracking errors (or runouts) must not exceed a certain threshold value, according to the standard of the disc.

For high speed recording, using for example a constant angle velocity (CAV) 16×, the high linear velocity of 16× is reached at the outside of the disc. At such a high writing speed, the writing margins are small, and are smaller than those present at lower speeds. The outside of the disc is thus more sensitive for axial and radial tracking errors or runouts.

Severe tracking errors or runouts may occur at high recording speeds and can result in bad write performance. Small runouts are generally error corrected, whereas larger may generally not be properly corrected for errors. Runouts larger than a certain size, thus means that uncorrectable data errors occur on the disc. Since uncorrectable data error cannot be allowed, they must hence be avoided.

The Japanese Patent Application JP-2003263767 A, discloses measuring servo tracking error signals during trial writing on a predetermined region of a recording medium at a predetermined principal linear velocity to optimize the recording speed by using a detection result of a means for detecting servo signal turbulence. Further, this document seem to disclose decreasing the recording speed if a servo tracking error exceeds a certain threshold.

The disclosure is thus based on servo tracking errors. Such a measure is a measure of tracking difficulties. It is difficult to relate any detected tracking errors to a possible data error of written data. Some tracking errors do not give rise to data errors. For these reasons such a measure is not optimal with respect to possible data errors.

There is thus a need to provide an improved measure in the process of determining an optimized data writing speed.

The present invention relates to determining a data writing speed for writing data on a medium, based on obtaining a measure that is related to the occurrence of possible data errors.

It is an object of the present invention to provide a data writing speed that is based on a data error measure.

According to a first aspect of the present invention, this object is achieved by a method for determining a data writing speed for writing data on a medium, using a predetermined writing power, comprising the steps writing a test data sequence on the medium using a first data writing speed, reading the written test data sequence from the medium, determining a written data error measure for the written test data sequence, and selecting data writing speed in dependence of the written data error measure, such that the data writing speed is optimized.

According to a second aspect of the present invention, this object is achieved by a method for writing data on a medium, using a data writing speed as determined by writing a test data sequence on the medium using a first data writing speed, reading the written test data sequence from the medium, determining a written data error measure for the written test data sequence, selecting data writing speed in dependence of the written data error measure, such that the data writing speed is optimized, and writing the data using the first writing speed.

According to a third aspect of the present invention, this object is achieved by a data writing speed determining unit for determining a data writing speed for writing data on a medium, using a predetermined writing power, comprising a data writing unit, arranged to write a test data sequence on the medium, a data reading unit, arranged to read the written test data sequence from the medium, a written data error measure determining unit, arranged to determine a written data error measure, a writing speed selecting unit, arranged to select data writing speed in dependence of the written data error measure, and a control unit, connected to the data writing unit, the data reading unit, the written data error measure determining unit and the writing speed selecting unit, said control unit being arranged to provide a test data sequence to the data writing unit, and to control the steps of writing a test data sequence on the medium using a first data writing speed, reading the written test data sequence from the medium, determining a written data error measure for the written test data sequence, and selecting data writing speed in dependence of the written data error measure, so that the data writing speed is optimized.

According to a fourth aspect of the present invention, this object is achieved by a data writing device comprising a data writing speed determining unit for determining a data writing speed for writing data on a medium, using a predetermined writing power, comprising a data writing unit, arranged to write a test data sequence on the medium, a data reading unit, arranged to read the written test data sequence from the medium, a written data error measure determining unit, arranged to determine a written data error measure, a writing speed selecting unit, arranged to select data writing speed in dependence of the written data error measure, and a control unit, connected to the data writing unit, the data reading unit, the written data error measure determining unit and the writing speed selecting unit, said control unit being arranged to provide a test data sequence to the data writing unit, and to control the steps of writing a test data sequence on the medium using a first data writing speed, reading the written test data sequence from the medium, determining a written data error measure for the written test data sequence, and selecting data writing speed in dependence of the written data error measure, in which the data writing device further comprises a data providing unit, arranged to provide data, a data medium driving unit, arranged to be able to hold the data medium to enable writing data on the data medium, so that the data writing speed is optimized.

According to a fifth aspect of the present invention, this object is achieved by a computer program product comprising a computer readable medium, having thereon computer program code means, to make a data computer or a data writing device execute, when said computer program code means is loaded in the computer or the data writing device: writing of a test data sequence on a data medium using a predetermined writing power and a first data writing speed, reading the written test data sequence from the medium, determining a written data error measure for the written test data sequence, and selecting data writing speed in dependence of the written data error measure, such that the data writing speed for writing data on the medium is optimized.

According to a sixth aspect of the present invention, this object is achieved by a computer program element comprising computer program code means to make a computer or data writing device execute: writing of a test data sequence on a data medium using a predetermined writing power and a first data writing speed, reading the written test data sequence from the medium, determining a written data error measure for the written test data sequence, and selecting data writing speed in dependence of the written data error measure, such that the data writing speed for writing data on the medium is optimized.

The medium on which data is written may be a digital versatile disc (DVD).

The present invention has the following advantage:

It is advantageous to use a data error measure on which the determination of the data writing speed is based, since it is important to monitor the data errors in order to enable providing an error-free data writing.

Direction of the independent claims and the advantage(s) thereof:

Claims 2 and 12 are directed to selecting a second lower data writing speed.

These claims carry the advantage that the data error measure decreases upon selecting the second lower data writing speed.

Claims 5 and 6 are directed to determining the block error rate and the bit error rate, respectively.

These are advantageous since the block error rate and the bit error rate directly relate to the occurrence of possible data errors.

Claim 8 is directed to using a first data writing speed in one part of a medium and a speed that is related to a second data writing speed in another part of the medium.

This is an advantage since the time that is required to write data on a medium, for which the first data writing speed cannot entirely be used, is enabled to be minimized.

The gist of the present invention is to select a data writing speed for which speed a data error measure is acceptable.

These and other aspects of the invention will be apparent from and elucidated with reference to the embodiments described hereinafter.

The present invention will now be described in more detail in relation to the enclosed drawings, in which:

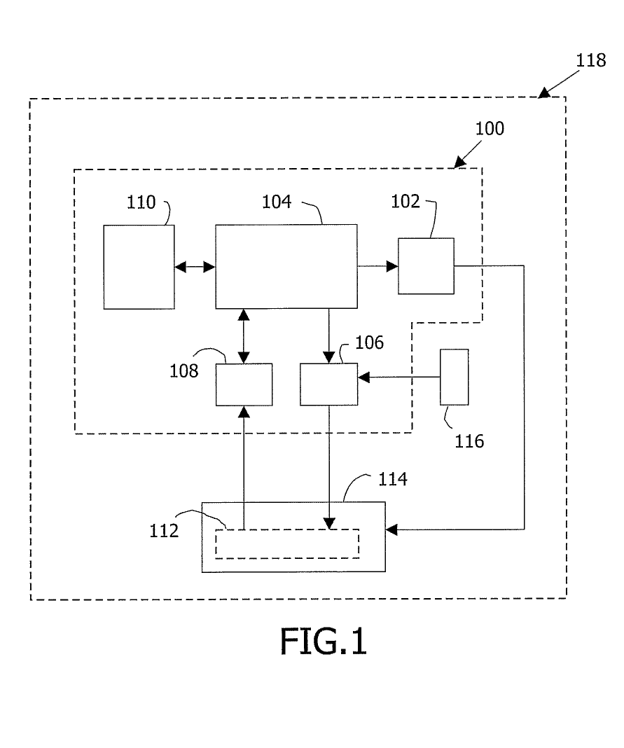

FIG. 1 is a schematic representation of a data writing device and a data writing unit according to a preferred embodiment of the present invention,

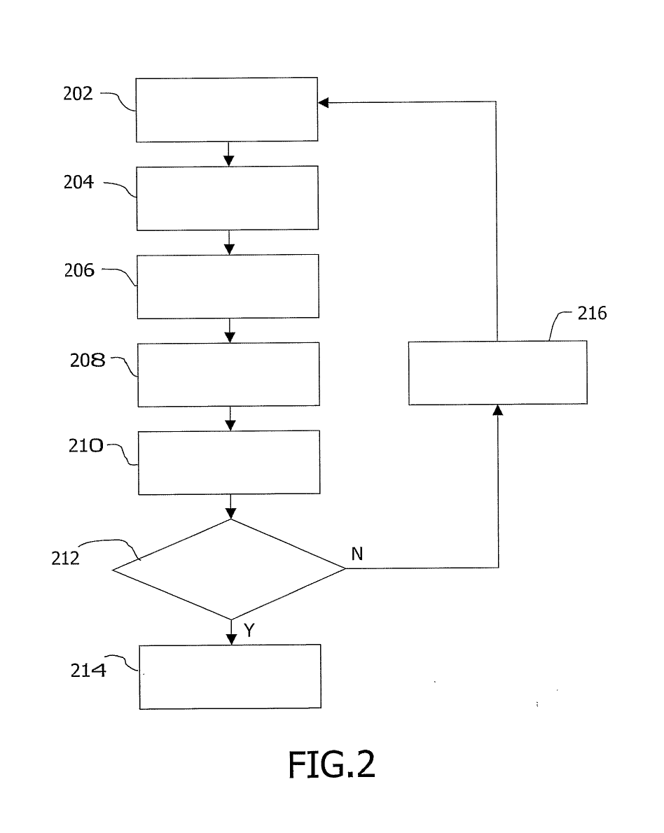

FIG. 2 presents a flowchart of a method for determining a data writing speed according to a preferred embodiment of the present invention,

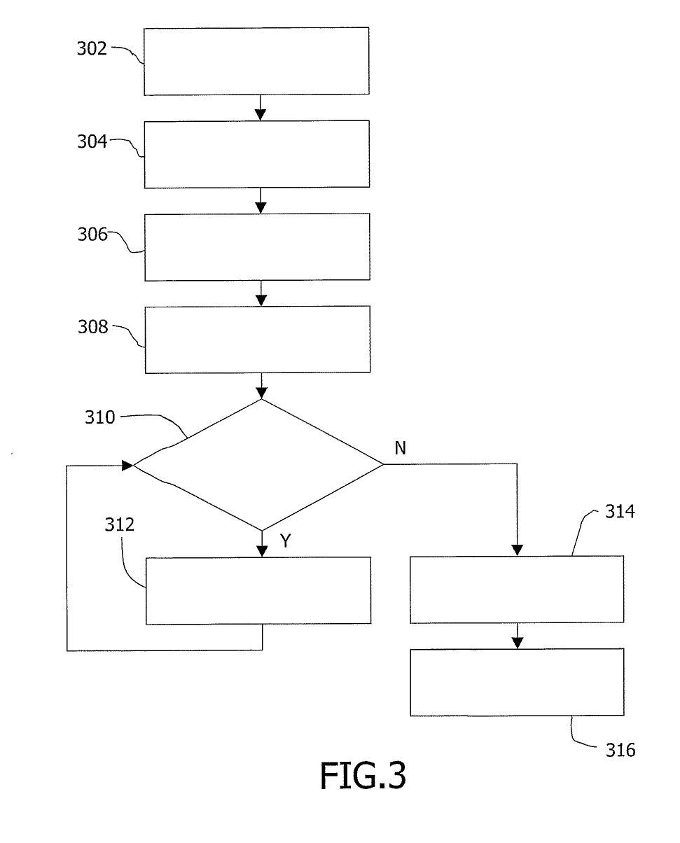

FIG. 3 presents a flowchart of a method for writing data on a medium according to one embodiment of the present invention,

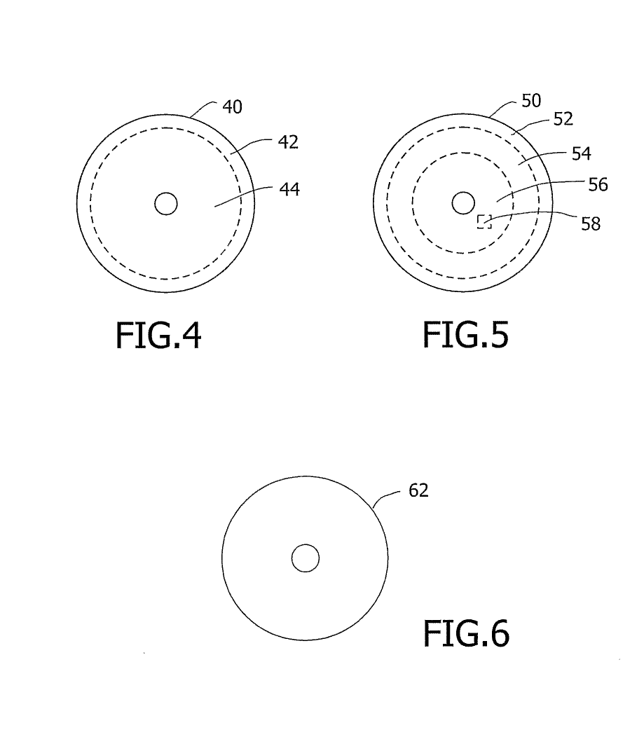

FIG. 4 shows an optical medium related to one embodiment of the present invention,

FIG. 5 shows another optical medium related to one embodiment of the present invention, and

FIG. 6 shows an optical medium according to a preferred embodiment of the present invention.

The present invention thus relates to determining a data writing speed for writing data on a medium, based on a data error measure that directly reflects the write performance.

Writing data on an optical medium at a high rotational speed is a challenging task.

Due to local disc variations, high speed writing of the discs makes high demands on the disc drive. A high class tracking performance is required in order to support a high data writing speed when writing electronic data on a data medium, such as an optical disc.

Tracking errors may be both radial and axial, and if tracking errors upon radial and axial tracking become too large, they cannot be properly error corrected. This results in unrecoverable data errors.

Since unrecoverable data errors cannot be allowed when writing electronic data on a data medium, the occurrence of such data errors is preferably monitored in a test phase, during which a data writing speed is being determined, based on a data error measure related to the test data written on the data medium.

It is preferable to use monitor the write performance by monitoring a write parameters that is directly connected to the data errors that may occur during writing. Examples of such write parameters are data error measures that are directly connected to the data written on the data medium. The bit error rate (BER) and the block error rate (BLER), are examples of such data error measures, and down below it is described how these data error measures can be used within the method for determining a data writing speed for writing electronic data on a data medium.

With reference to FIG. 1 showing a schematic representation of a data writing device, the present invention is explained.

According to one embodiment of the present invention the data writing device, 118, for determining a data writing speed comprises a data writing speed determining unit 100, a data providing unit 116, and a data medium driving unit 114, in which a data medium 112 may be loaded. According to one embodiment of the present invention the data medium 112 is a digital versatile disc (DVD), but it may any other type of disc, such as a Blu-ray disc, a compact disc (CD), or a mini disc (MD), to mention a few only.

The data providing unit 116 is a data interface, via which the data to be stored on the data medium is forwarded, according to a preferred embodiment of the present invention. However the data providing unit 116 may have a storage capacity and hence function as a data memory for storing at least part of an amount of electronic data to be written on the data medium 112.

The data writing speed determining unit 100 comprises a writing speed selecting unit 102, a data writing unit 106, a data reading unit 108 and a written data error measure determining unit 110, which all are connected to a control unit 104 that in itself is comprised in the data writing speed determining unit 100, as shown in FIG. 1.

Further, the data writing speed determining unit 100 has connections to the data medium driving unit 114, by way of the writing speed selecting unit 102, the data writing unit 106 and the data reading unit 108, all being connected to the data medium driving unit 114, again as shown in FIG. 1. The data providing unit 116 is also connected to the data writing speed determining unit 100, in that the data providing unit 116 is connected to the data writing unit 106.

The connections between the data writing speed determining unit 100, the data providing unit 116 and the data medium driving unit 114, as well as the connections internal to the data writing speed determining unit 100, as described above, are connections according to one embodiment of the present invention. It is understood that connections between the units, may be established in a different manner according to another embodiment of the present invention.

Also according to a different embodiment of the present invention the data medium driving unit 114 may comprise one or more of the units that, according to an embodiment of the present invention as explained above, are located within the data writing speed determining unit 100. For instance, the data writing unit 106 and the data reading unit 108 may be comprised within the data medium driving unit 114. Moreover, according to yet a different embodiment the data writing unit 106 and the data reading unit 108 may be combined in one single data reading/writing unit. The data writing unit 106 is arranged to write a test data sequence on the outside region of the data medium 112. According to one preferred embodiment of the present invention, the test data sequence is a random test data sequence. This is advantageous since this type of sequence is considered to be a good model of electronic data that may be stored on the data medium.

FIGS. 4 and 5, each show an optical disc, as examples of a data medium, which are related to the present invention. These optical discs, 40 and 50, respectively, each have an outside region as indicated with 42 and 52, respectively. These outside regions are test data areas onto which test data is written during a test phase prior to storing electronic data on the disc.

According to the present invention the test data sequence is read by the data reading unit 108, after which the data reading unit 108 forwards the read test data to the control unit 104. The control unit 104 now has access to both the test data sequence that was written to the data medium and the data test sequence that was read from the data medium. It is now the task of the written data error measure determining unit 110 to determine a written data error measure for the test data sequence that was written on the data medium 112.

By providing the written test data sequence and the read data test sequence by the control unit 104 to the written data error measure determining unit 110, a data error measure can be determined by comparing the two data sequences.

Based on the comparison made by the written data error measure determining unit 110, the control unit 104 controls the writing speed selecting unit 102 to select a speed. This speed information is forwarded to the data medium driving unit 114, as indicated in FIG. 1.

The method for determining a data writing speed for writing electronic data on a data medium, according to the present invention is now explained in more detail with reference to FIG. 2 with accompanying Table 1, showing a flow chart of the method for determining a data writing speed and presenting short task descriptions of said method, respectively.

TABLE 1
Short task descriptions of the method for determining a data writing
speed according to one embodiment of the present invention.

| STEP NO. | SHORT TASK DESCRIPTIONS |
|---|---|
| 202 | Performing optimal power control |
| 204 | Writing data sequence using optimal power |
| 206 | Reading written data sequence |
| 208 | Comparing data sequence with written data sequence |
| 210 | Obtaining block error rate, BLER |
| 212 | BLER ≦ BLER_threshold? |
| 214 | Utilizing the data writing speed |
| 216 | Decreasing writing speed |

The first step, step 202, of the method is the step of performing an optimal power control (OPC). This step is known from the literature and is therefore not described in detail here. In this step an optimal write power is determined, for subsequent storing of electronic data on the data medium. Since the OPC is performed for each writing speed that may be used, the flow-chart starts by performing said OPC.

This step is performed by the data writing device 118, preferably by using one or more of the available units within the data writing speed determining unit 100.

Having obtained an optimized writing power in step 202, a test data sequence is written on the data medium 112 utilizing a first data writing speed and by using the determined optimized writing power, step 204. This step is performed by the data writing unit 106 under the control of the control unit 104.

As there is an aspiration for writing as fast as possible, this first data writing speed is chosen to be a high CAV speed, such as 16×. This first data writing speed may however also be 20× or 24×, dependent on the performance of the data writing device 118 and the grade of the data medium 112 available.

In this step of writing a test data sequence, the test data sequence is written by using the highest possible writing speed. As the writing speed is a constant angle velocity speed, the outside of the data medium has the highest linear velocity. As the test data sequence is written in a test region 32, 42 that is located at that very outside of the data medium, a successful writing in this region automatically means that writing at other regions or parts of the data medium will also be successful, as the linear writing velocity is lower in regions located closer to the middle of the spinning data medium. The relation between angular velocities, linear velocities and the distance from the writing position to the middle of the disc, that is the writing position radius, is further described down below.

The first test data writing is thus performed utilizing a high writing speed, preferably a constant angle velocity (CAV) 16× speed.

According to one embodiment of the present invention, the test data sequence is provided by the control unit 104 but it may as well be obtained elsewhere from.

After the test data sequence is written on the data medium 112 by the data writing unit 106, in step 204, utilizing the first data writing speed, the step of reading the written test data sequence from the data medium by the reading unit 108, step 206, is performed.

Writing a test data sequence on a data medium followed by reading the written test data sequence may seem odd. However, since errors may occur during writing due to disc imperfections, the data that can be read from the data medium may differ from the data that actually were written on the data medium. Also, since writing margins decrease with increasing data writing speed, choosing a high data writing speed means that the writing margins are small which also may influence the result of writing test data sequences.

The next step of the method being described is the step of comparing the two data sequences by the written data error measure determining unit 110, step 208. This unit thus compares the two data sequences in order to determine a data error measure that is intended to reflect data errors of the written data. The subsequent step of the method is the step of obtaining the block error rate (BLER), being one example of a data error measure that is directly related to data errors that may occur upon writing data on a data medium, step 210. This step is performed by the written data error measure determining unit 110, which has access to the two test data sequences.

According to another embodiment of the present invention the data error measure that is obtained is the bit error rate (BER) of the written data.

The two data error measures, that is the block error rate and the bit error rate, are both direct measures of the errors that may occur in the written data. As described earlier, it is advantageous to use an error measure that is directly related to the errors occurring in the data, since it is precisely the data errors of written data that are important to detect in order to avoid giving rise to such data errors.

Having obtained the BLER for the written data, according to one embodiment of the present invention, the value of BLER is related to a BLER-threshold in the step of determining whether BLER is smaller than or equal to the BLER-threshold, BLER_threshold, or not, step 212. This step may be performed by the control unit 104. In one alternative, this step is performed in the written data error measure determining unit 110.

If it is determined that BLER is smaller than or equal to BLER_threshold, the present and first data writing speed that was used to write a test data sequence on the outside of a data medium, in a location of a data medium where the linear velocity is the highest, can be utilized to write data in any other part of the medium using this CAV data writing speed.

For a relatively small BLER-value the data errors may be recovered, whereas error correction for higher BLER-values is much more difficult and may not be successful. The BLER_threshold is typically set such that no unrecoverable data errors are resulted in the written data for which the BLER-value is lower than or equal to BLER_threshold.

After having determined whether the BLER satisfies the BLER-criteria, that is whether it is smaller than or equal to BLER_threshold, or not, in step 212, the next step of utilizing the data writing speed, step 214, is followed. Since the selected data writing speed that was used for the test data sequence fulfilled the criteria, this CAV speed can be used to write electronic data in the entire data medium region 44 as shown in FIG. 4, showing an optical medium related to the present invention.

Within the data writing device 118 it is the writing speed selecting unit 102 that does not select another speed but keeps the already selected data writing speed for subsequent data recording.

If, however, it is determined in step 212, that BLER is not smaller than or equal to BLER_threshold, the BLER at this very data writing speed, the first data writing speed, is not acceptable. In this case the step of decreasing the data writing speed, step 216, is performed. This step of decreasing the data writing speed is performed by the writing speed selecting unit 102 under the control of the control unit 104.

This lower second data writing speed is thus selected in a new loop of the method for determining a data writing speed, that is in the steps of performing an optimal power control (OPC) step 202, writing a test data sequence on a data medium step 204, reading the written test data sequence step 206, comparing the written test data sequence and the read test data sequence step 208, obtaining a new block error rate, BLER step 210, for this lower second data writing speed, determining whether this new BLER is smaller than or equal to BLER_threshold, or not step 212 and utilizing the second data writing speed or possibly further decreasing the data writing speed (steps 214,216).

Since using a CAV 16× speed, the linear velocity of a position of the spinning data medium is dependent on the distance from the middle of the data medium to the write/read position on the data medium, that is the current radius for the position on the data medium. For a CAV 16× speed the linear velocity is 16× at the outside of the data medium and hence lower at other positions on the data medium since these have a smaller radius. The geometry of a DVD disc as one example of a data medium, is such that the outside of such a DVD has a radius of approximately 58 mm and the inside has a radius of approximately 22 mm. Since the ratio between the linear velocity and the radius is constant due to the angle velocity being constant when using a CAV data writing speed, the linear velocity of a position of the data medium, spinning at a CAV of 16×, may be obtained from equation 1.

Linear velocity of a position having radius R in mm≈(R/58)−16× (1)

The linear velocity of the inside of the DVD, which has a radius of 22 mm, is thus approximately (22/58) 16×, which is about 6×.

Returning to the case for which the first data writing speed of CAV 16× could not be utilized at the outside of the data medium, whereas the data writing speed of a CAV 12× could be utilized in order to obtain an acceptable error measure for test data sequence writing, the method for writing electronic data on the medium will now be described with reference to FIG. 3, presenting a flowchart of the method for writing electronic data on a medium according to one embodiment of the present invention.

TABLE 2
Short task descriptions of the method for writing data on a
medium according to one embodiment of the present invention.

| STEP NO. | SHORT TASK DESCRIPTIONS |
|---|---|
| 302 | Obtaining first data writing speed |
| 304 | Obtaining second data writing speed |
| 306 | Obtaining speed related to second data writing speed |
| 308 | Monitoring linear speed |
| 310 | Linear speed being monitored < speed related to second |
| | data writing speed |
| 312 | Writing data using first speed |
| 314 | Writing data using speed related to second speed |
| 316 | Ending writing |

This method using multiple data writing speeds starts with the step of obtaining the first data writing speed for writing electronic data on the medium step 302. This first data writing speed may be CAV 16×, but may for example also be CAV 20× or CAV 24×, to mention a few alternative data writing speeds. Next, the step of obtaining a second data writing speed is performed, step 304. This second data writing speed is typically lower than the first data writing speed. In this case, for which the first data writing speed is CAV 16×, is the second data writing speed CAV 12×.

Now, having obtained the lower second data writing speed, which in this example is CAV 12×, the step of obtaining a speed related to the second data writing speed is performed in step 306. In this example this step comprises obtaining the speed of constant linear velocity (CLV) 12×, that is related to the second data writing speed being CAV 12×. Next, the step of starting monitoring the linear speed of the writing/reading position of the medium is performed in step 308. From this step the linear speed of the writing/reading position of the medium is being monitored. In the subsequent step, step 310, it is determined whether the condition “Linear speed being monitored is less than the obtained linear speed related to the second data writing speed” applies or not. If the linear speed being monitored is less than the obtained linear speed that is related to the second data writing speed, as determined in step 310, the step of writing electronic data using the first data writing speed is executed, step 312. At this step electronic data is thus written sing a data writing speed of CAV 16×. This step, step 312 is executed as long as long as the condition “linear speed being monitored is less than the obtained linear speed related to the second data writing speed” applies. By using a constant angle velocity and writing from the inside of a rotating medium to the outside, the linear speed being monitored increases with time. As soon as this condition does not apply, that is as soon as the linear speed being monitored equals to the linear speed related to the second data writing speed, the condition above does not apply, for which reason step 312 is no longer executed. Rather, the step of writing electronic data using the linear speed that is related to the second data writing speed, is executed, step 314. The switch between using the first data writing speed to using a linear speed (CLV 12×) related to the second data writing speed (CAV 12×), takes place where the radius for the writing/reading position of the medium is approximately (12×/16×)*58 mm, which equals approximately 44 mm. It is thus at a radius of 44 mm that the linear velocity is 12× when using a CAV 16× data writing speed. Since a data writing speed of CAV 12× was used in the successful test data sequence writing at the outside of the data medium, a linear velocity of 12× can be successfully used. Electronic data thus is written using a constant linear velocity speed of 12×.

The same electronic data is hence written in a second part of the medium by using a speed that is different from the speed that was used to write electronic data in a first part. Next, step 316 is executed, ending the step of writing electronic data on the medium using the linear speed that is related to the second data writing speed.

Again referring to FIG. 5, showing an optical medium 50 related to one embodiment of the present invention, a CAV 16× data writing speed is used in a first part 56 of the data medium 50. In a second part 54 of the data medium 50, a constant linear velocity (CLV) of 12× is utilized. This region 54 is thus the region between the radii of 44 and 58 mm of the data medium 50. A data writing/reading position 58 is also displayed.

If, however, it is determined that the BLER as obtained at the CAV 12× is larger than or equal to BLER_threshold, in step 212, of the method for determining a data writing speed, the next step is further decreasing the data writing speed, step 216. This decrease from CAV 12× is then to CAV 8×, at which a new test data sequence is written. As described above, a new BLER-value is obtained and compared with BLER_threshold to determine whether the data writing speed used, that is CAV 8×, can be utilized for writing a test data sequence without the occurrence of unrecoverable data errors. If the so obtained BLER is smaller than or equal to BLER_threshold the second data writing speed CAV 8× is utilized.

Continuing to the method for writing electronic data, the CAV 8× is obtained as being the second data writing speed in step 304 in this case. In step 306 obtaining a speed related to the second data writing speed (CAV 8×) a CLV 8× is obtained. In the subsequent step of starting monitoring, step 308, the linear speed of the writing/reading position 58 of the medium 50 is executed, similar to the case as described above. As long as the condition, linear speed being monitored is lower than the linear speed related to the second data writing speed, that is lower than CLV 8×, applies, electronic data is written using the first data writing speed, CAV 16×. This condition applies until the radius of a writing/reading position of the medium reaches, following equation 1, approximately (8×/16×)−58 mm=29 mm, at which radius the linear speed of the writing position reaches a linear speed of 8×. In this case the CAV 16× data writing speed is thus used from the inside of the medium, for which the radius is about 22 mm, until the radius for a writing position 58 on the medium reaches about 29 mm, defining the first part of the medium, indicated as 56. As soon as the speed condition, as determined in step 310, does not apply, writing electronic data is performed in a second part 54 of the medium 50, by using a linear data writing speed of CLV 8× is used, provided there is an order to write electronic data. The second part of the medium is in this example defined as the part of the medium between the radii of 29 mm and 58 mm.

In one alternative of the present invention a data writing speed of CLV 6× may be used throughout the data medium, in case no higher CAV data writing speeds than 6× can be used when fulfilling the BLER-criteria from step 212 in the method for determining a data writing speed.

FIG. 6 schematically shows a computer program product according to one embodiment of the present invention, having thereon computer program code means. When the computer program code means, comprised on the computer program product, is loaded in a computer or possibly the data writing device itself, said computer or possibly the data writing device itself, executes writing of a test data sequence on a data medium using a predetermined writing power and a first data writing speed, reading the written test data sequence from the medium, determining a written data error measure for the written test data sequence, and selecting data writing speed in dependence of the written data error measure, such that the data writing speed for writing electronic data on the medium is optimized.

One example of such a computer program product is a CD-ROM, but it can however be any kind of readable disc that can be inserted in a computer, such as a DVD-disc, an MD-disc or any other kind of computer program product. Also the computer program product may be a portable memory, such as a flash-based memory or even a memory of the type being volatile.

In addition, the computer program element according to the present invention may be downloaded from a server via for instance the Internet or any other wired or wireless network.

Moreover, the computer typically comprises a control unit, a memory unit and an input/output unit.

It is emphasized that this invention can be varied in many more ways, of which the alternative embodiments below only are examples of a few. These different embodiments are hence non-limiting examples. The scope of the present invention, however, is only limited by the subsequently following claims.

According to a another embodiment of the present invention, other data writing speeds than the ones as mentioned above may be used. For instance, in case CAV 16× does not fulfill the BLER-criteria, a data writing speed of CAV 15× may be used to write a test data sequence on a data medium in order to determine whether a new BLER-value is lower than a BLER_threshold or not, etc. following the steps of the method for determining a data writing speed.

According to yet another embodiment of the present invention the data writing speed is determined based on obtaining the jitter of written data, determining whether the obtained gitter-value is larger than a gitter-threshold and selecting a data writing speed in dependence on this determination. This data error measure, that is the jitter, may well be combined with another data error measure, such as the BLER or the BER, as mentioned above, for the determination of a data writing speed according to the present invention.

According to yet another embodiment of the present invention the jitter may additionally be measured of a written test data sequence in order to determine a second data error measure.

It shall be paid attention to that:

“Comprising” or “comprises” does not exclude other elements, steps, units, etc.

“A” or “an” does not exclude a plurality of the respective items.

A single unit may fulfill the functions of several units recited in the claims.

The reference signs in the claims shall not be construed as limiting the scope.

The method, the data writing speed determining unit, the data writing device, the computer program product and the computer program element for determining a data writing speed, as well as the method for writing electronic data on a medium, according to the present invention, have the following general advantage:

The data writing speed that is determined by using the present invention is data error secure in the sense that a data error measure that is directly related to the error that would occur when storing electronic data on an optical medium, is determined and upon which the data writing speed is determined.

An additional advantage is that the data error measure decreases upon selecting the second lower data writing speed in the method for determining a data writing speed.

Using a first data writing speed in one part of a medium and a speed that is related to a second data writing speed in another part of the medium is an advantage since the time that is required to write electronic data on a medium, for which the first data writing speed cannot entirely be used, can be minimized.

1. A method for determining a data writing speed for writing data on a medium (112,40,50), using a predetermined writing power, comprising the steps:
writing a test data sequence on the medium (112,40,50) using a first data writing speed (step 204),
reading the written test data sequence from the medium (112, step 206), determining a written data error measure for the written test data sequence (steps 208,210), and
selecting data writing speed in dependence of the written data error measure (steps 214,216),
such that the data writing speed is optimized.

2. The method according to claim 1, in which the step of selecting data writing speed (steps 214,216), includes selecting a lower second data writing speed if the written data error measure is higher than a written data error threshold (steps 212,216).

3. The method according to claim 1, in which the step of selecting data writing speed (steps 214,216), includes maintaining the first data writing speed if the written data error measure is lower than or equal to the written data error threshold (steps 212,214).

4. The method according to claim 1, in which the step of determining a written data error measure (steps 208,210), comprises comparing the read test data sequence with the written test data sequence (step 208).

5. The method according to claim 1, in which the written data error measure is the block error rate.

6. The method according to claim 1, in which the written data error measure is the bit error rate.

7. A method for writing data on a medium (112,40,50), using a data writing speed as determined according to claim 1, comprising the step writing data using the first writing speed (step 312).

8. A method for writing data on a medium (112), using a data writing speed as determined according to claim 2, comprising the step writing data on a first part (56) of the medium (112,50), using the first data writing speed (step 312), and writing data on a second part (54) of the medium (112,50), using a data writing speed related to the second data writing speed.

9. The method for writing data on a medium (112,40,50), according to claim 2, in which the first data writing speed is a constant angular speed, and the speed related to the second data writing speed is a constant linear speed.

10. The method for writing data on a medium (112,40,50), according to claim 7, in which the linear speed of a writing position at the outside of the first part (56) of the medium (50) when using the first data writing speed, equals the linear speed of at least one writing position of the second part (54) of the medium (50) when using the speed related to the second data writing speed.

11. A data writing speed determining unit (100) for determining a data writing speed for writing data on a medium (112,40,50), using a predetermined writing power, comprising:
a data writing unit (106), arranged to write a test data sequence on the medium (112,40,50),
a data reading unit (108), arranged to read the written test data sequence from the medium (112,40,50),
a written data error measure determining unit (110), arranged to determine a written data error measure,
a writing speed selecting unit (102), arranged to select data writing speed in dependence of the written data error measure, and
a control unit (104), connected to the data writing unit (106), the data reading unit (108), the written data error measure determining unit (110) and the writing speed selecting unit (102), said control unit (104) being arranged to provide a test data sequence to the data writing unit (106), and to control the steps of writing a test data sequence on the medium using a first data writing speed (step 204), reading the written test data sequence from the medium (112,40,50,step 206), determining a written data error measure for the written test data sequence (steps 208,210) and selecting data writing speed in dependence of the written data error measure (steps 214,216),
so that the data writing speed is optimized.

12. The data writing speed determining unit (100) according to claim 11, in which the writing speed selecting unit (102) further is arranged to select a lower second data writing speed if the written data error measure is higher than a written data error threshold (steps 216).

13. The data writing speed determining unit (100) according to claim 11, in which the writing speed selecting unit (102) further is arranged to maintain the first data writing speed if the written data error measure is lower than or equal to a written data error threshold (step 214).

14. The data writing speed determining unit (100) according to claim 11, in which the written data error measure determining unit (110), further is arranged to compare the read test data sequence with the written test data sequence (step 208).

15. A data writing device (118) comprising a data writing speed determining unit (100) for determining a data writing speed for writing data on a medium (112,40,50), using a predetermined writing power, comprising:
a data writing unit (106), arranged to write a test data sequence on the medium (112,40,50),
a data reading unit (108), arranged to read the written test data sequence from the medium (112,40,50),
a written data error measure determining unit (110), arranged to determine a written data error measure,
a writing speed selecting unit (102), arranged to select data writing speed in dependence of the written data error measure, and
a control unit (104), connected to the data writing unit (106), the data reading unit (108), the written data error measure determining unit (110) and the writing speed selecting unit (102), said control unit (104) being arranged to provide a test data sequence to the data writing unit (106), and to control the steps of writing a test data sequence on the medium (112,40,50) using a first data writing speed (step 204), reading the written test data sequence from the medium (112,40,50,step 206), determining a written data error measure for the written test data sequence (steps 208,210), and selecting data writing speed in dependence of the written data error measure (steps 214,216),
in which the data writing device further comprises:
a data providing unit (116), arranged to provide data,
a data medium driving unit (114), arranged to be able to hold the data medium (112,40,50) to enable writing data on the data medium (112,40,50),
so that the data writing speed is optimized.

16. The data writing device (118) according to claim 15, in which the data writing unit (106) further is arranged to write data on the data medium (112,40,50).

17. A computer program product (62) comprising a computer readable medium, having thereon computer program code means, to make a data writing device (118) or a computer execute, when said computer program code means is loaded in the data writing device (118) or the computer:
writing of a test data sequence on a data medium (112,40,50) using a predetermined writing power and a first data writing speed (step 204),
reading the written test data sequence from the medium (112,40,50,step 206), determining a written data error measure for the written test data sequence (steps 208,210), and
selecting data writing speed in dependence of the written data error measure (steps 214,216),
such that the data writing speed for writing data on the medium (112,40,50) is optimized.

18. A computer program element comprising computer program code means to make a data writing device (118) or a computer execute:
writing of a test data sequence on a data medium (112,40,50) using a predetermined writing power and a first data writing speed (step 204),
reading the written test data sequence from the medium (112,40,50,step 206),
determining a written data error measure for the written test data sequence (steps 208,210), and
selecting data writing speed in dependence of the written data error measure (steps 214,216),
such that the data writing speed for writing data on the medium (112,40,50) is optimized.
